(19) United States
(12) Patent Application Publication
(10) Pub. No.: US 2007/0281049 A1
(43) Pub. Date: Dec. 6, 2007

(54) Wire mat and apparatus for making the same

(76) Inventor: John Pereira, Rehoboth, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/447,243

(22) Filed: Jun. 5, 2006

(51) Int. Cl. B27N 3/14; B23Q 7/00

(52) U.S. Cl. 425/81.1; 425/83.1; 29/745; 29/742; 29/33 P

(57) ABSTRACT

An apparatus for forming a wire mat includes a wire guide for simultaneously guiding multiple moving wires onto a moving plastic sheet. A pressure roll arrangement downstream from the wire guide has a first pressure roller and a second pressure roller that is engageable with the first pressure roller. The pressure rollers can apply pressure along a line of contact for combining the multiple wires with the plastic sheet between the rollers. The wire guide and one of the pressure rollers are configured to allow a voltage potential to be formed between the wire guide and the pressure roller for causing current to flow and heating of a portion of the wires between the wire guide and the pressure roller. The portion of the wires that is heated is capable of heating portions of the plastic sheet to allow the wires to be embedded into the plastic sheet by the pressure rollers along the line of contact to form a wire mat.

### BACKGROUND

Windshields for motor vehicles can include a wire mat heater laminated between the glass layers of the windshield for heating and defrosting the windshield. The wire mat heater has heating wires which can be formed in a wave-like pattern so that the wires are less noticeable. Typically, the wire mat heater includes a plastic sheet to which the heating wires are applied. One method of applying the heating wires onto the plastic sheet is to first wrap and secure the plastic sheet around a rotatable cylindrical drum. Then a strand of wire is pulled from a spool and wrapped onto the plastic sheet while the drum is rotated. The longitudinal location at which the wire is applied is longitudinally translated to evenly distribute the wire over the plastic sheet. The strand of the wire can be applied in a wavelike pattern, for example, by crimping the wire between gears. Although two wire mats can be formed simultaneously on a single drum, the process typically takes considerable time, for example, about one-half hour is common.

### SUMMARY

The present invention can provide an apparatus for forming a wire mat more quickly than by prior methods. The apparatus can include a wire guide for simultaneously guiding multiple moving wires onto a moving plastic sheet. A pressure roll arrangement can be downstream from the wire guide and can have a first pressure roller and a second pressure roller that is engageable with the first pressure roller. The pressure rollers can apply pressure along a line of contact for combining the multiple wires with the plastic sheet between the rollers. The wire guide and one of the pressure rollers can be configured to allow a voltage potential to be formed between the wire guide and the pressure roller for causing current to flow and heating of a portion of the wires between the wire guide and the pressure roller. The portion of the wires that is heated is capable of heating portions of the plastic sheet to allow the wires to be embedded into the plastic sheet by the pressure rollers along the line of contact to form a wire mat.

In particular embodiments, the pressure rollers of the pressure roller arrangement can be driven by a drive system. An oscillating drive system can provide relative side to side oscillation between the wire guide and the pressure rollers for applying the wires on the plastic sheet in a wave pattern. The multiple wires can be drawn from respective multiple spools. The spools can be positioned along a horizontal plane in rows and can be rotatable about vertical axes. The multiple spools and the wire guide can be oscillated side to side in unison by the oscillating drive system. The wire guide can be capable of oscillating side to side while the pressure roll arrangement remains stationary, whereby the wave pattern of the wires can be formed on the plastic sheet at the line of contact of the pressure rollers. The first pressure roller can be a top roller, whereby the voltage potential can be formed between the wire guide and the top pressure roller. The wire guide can be configured for simultaneously guiding at least one hundred wires side by side onto the plastic sheet. The wire guide can include a series of lateral slots. A pinch roll arrangement including a first pinch roller and a second pinch roller can be located downstream from the pressure roll arrangement. The pinch roll arrangement can also be driven by the drive system.

The present invention can additionally provide an apparatus for forming a wire mat which can include a wire guide for simultaneously guiding multiple moving wires from respective multiple spools onto a moving plastic sheet. A pressure roll arrangement can be downstream from the wire guide and include a first pressure roller and a second pressure roller that is engageable with the first pressure roller. The pressure rollers can apply pressure along a line of contact for combining the multiple wires with the plastic sheet between the rollers to form a wire mat. An oscillating drive system can provide relative side to side oscillation between the wire guide and the pressure rollers for applying the wires on the plastic sheet in a wave pattern. The multiple spools and the wire guide can be oscillated side to side in unison by the oscillating drive system.

The present invention can further provide a wire mat which can include a plastic sheet having a series of wires embedded in the plastic sheet. A buss bar arrangement having buss bars can be included. At least some of the buss bars can have an exposed solder clad surface embedded into the plastic sheet and facing and being soldered to at least some of the embedded wires.

In particular embodiments, an electrical connector arrangement can be electrically connected with the buss bars. The wire mat can be a heating element and the wires can be heating wires. The wires can be embedded in the plastic sheet side by side in wave patterns.

The present invention can also provide a window which can include a first window sheet and a second window sheet. A wire mat can be between the window sheets. The wire mat can include a plastic sheet having a series of wires embedded in the plastic sheet. A buss bar arrangement having buss bars can be included. At least some of the buss bars can have an exposed solder clad surface embedded into the plastic sheet and facing and being soldered to at least some of the embedded wires.

In particular embodiments, the wire mat can be a heating element and the wires can be heating wires. An electrical connector arrangement can be electrically connected with the buss bars. The wires can be embedded in the plastic sheet side by side in wave patterns.

The present invention can also provide a plastic window having two sides. A wire mat can be positioned between the two sides. The wire mat can include a series of wires in electrical circuit with a buss bar arrangement.

The present invention can also provide a method for forming a wire mat including simultaneously guiding multiple moving wires onto a moving plastic sheet with a wire guide. The multiple wires can be combined with the plastic sheet with a pressure roll arrangement located downstream from the wire guide, along a line of contact between a first pressure roller and a second pressure roller. A voltage potential can be formed between the wire guide and one of the pressure rollers for causing current to flow and heating of a portion of the wires between the wire guide and the pressure roller. The portion of the wires that is heated is capable of heating portions of the plastic sheet to allow the wires to be embedded into the plastic sheet by the pressure rollers along the line of contact to form a wire mat.

The present invention can also provide a method for forming a wire mat including simultaneously guiding multiple moving wires from respective multiple spools onto a moving plastic sheet with a wire guide. The multiple wires can be combined with the plastic sheet with a pressure roll arrangement located downstream from the wire guide, along a line of contact between a first pressure roller and a second pressure roller to form a wire mat. Relative side to side oscillation can be provided between the wire guide and the pressure rollers with an oscillating drive system for applying the wires on the plastic sheet in a wave pattern. The multiple spools and the wire guide can be oscillated side to side in unison by the oscillating drive system.

The present invention can also provide a method of forming a wire mat including providing a plastic sheet and embedding a series of wires in the plastic sheet. A buss bar arrangement having buss bars can be applied on the plastic sheet. At least some of the buss bars can have an exposed solder clad surface embedded into the plastic sheet and facing and being soldered to at least some of the embedded wires.

The present invention can also provide a method of forming a window including positioning a wire mat between first and second window sheets. The wire mat can include a plastic sheet having a series of wires embedded in the plastic sheet. A buss bar arrangement having buss bars can be included. At least some of the buss bars can have an exposed solder clad surface embedded into the plastic sheet and facing and being soldered to some of the embedded wires.

The present invention can also provide a method of forming a window. A plastic window having two sides can be formed. A wire mat can be positioned between the two sides. The wire mat can include a series of wires in electrical circuit with a buss bar arrangement.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic drawing of an embodiment of an apparatus for forming a wire mat.

FIG. 2 is a plan view of a section of a wire mat having wires embedded in wave patterns.

FIG. 3 is a plan view of a wire mat having buss bars soldered to the wires.

FIG. 4 is a schematic sectional drawing of a wire mat depicting a buss bar embedded into the plastic sheet and soldered to embedded wires.

FIG. 5 is a plan view of a wire mat cut to shape with electrical connectors connected to the buss bars.

FIG. 5A is a cross sectional view of a window having a wire mat laminated between glass layers.

FIG. 6 is a side view of an embodiment of an apparatus for forming a wire mat.

FIG. 7 is a top view of the oscillating assembly of the apparatus of FIG. 6.

FIG. 8 is a side schematic view of a drive wheel transmission.

### DETAILED DESCRIPTION

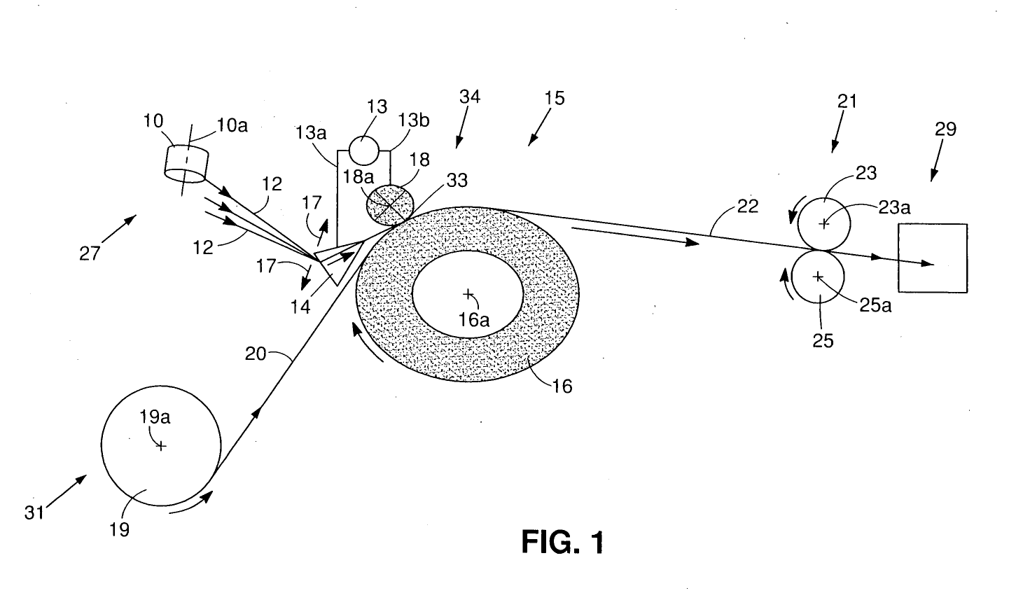

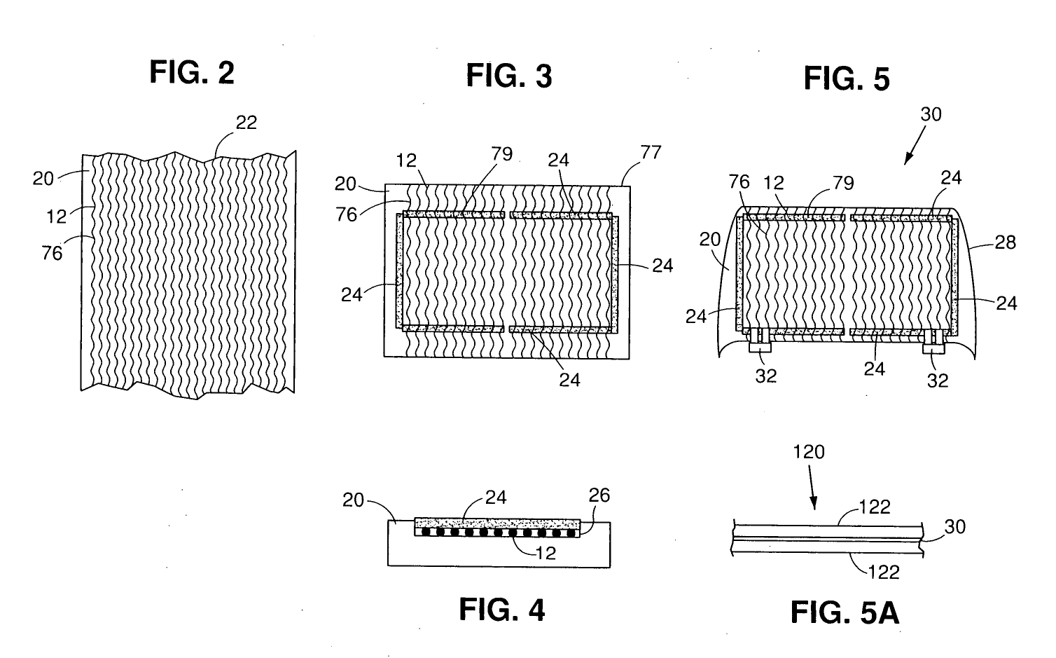

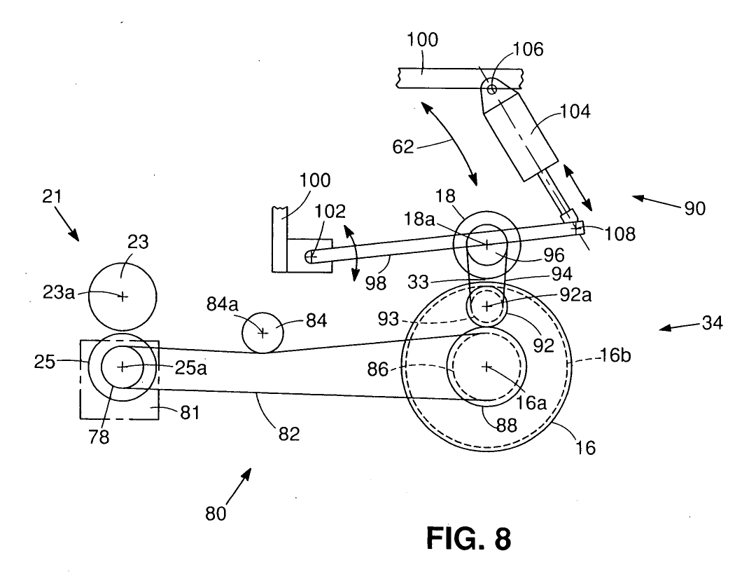

FIG. 1 depicts an embodiment of a wire mat apparatus 15 which can make a wire mat 22 or 30 (FIG. 5). Apparatus 15 can include a sheet unwind station 31 for unwinding a sheet of optically see through flexible material such as a plastic sheet 20 from a roll 19, and a wire unwind station 27 for simultaneously unwinding multiple wires 12. Often over 100 wires can be simultaneously unwound, and commonly can be in the range from 500 to 600 wires. The wires 12 can be unwound from multiple spools 10. A wire guide assembly 14 can receive the wires 12 pulled from the unwind station 27 and can simultaneously guide the wires 12 while the wires 12 are longitudinally moving in the direction of the arrows in a side by side arrangement or relationship onto the moving plastic sheet 20 at or about a pressure roll assembly or arrangement 34. The wire guide assembly 14 can move or oscillate side to side relative to the plane of the plastic sheet 20 (in the direction of lateral arrows 17) to apply the wires 12 onto the plastic sheet 20 in side by side wave patterns 76 (FIG. 2). The pressure roll assembly 34 can be driven by a drive system 80 (FIG. 8) and can include a first or top pressure roller 18, and a second or bottom pressure roller 16.

A power source or supply 13 can be in electrical circuit with the wire guide assembly 14 and one of the pressure rollers, for example, the top pressure roller 18 via lines 13a and 13b, so that a voltage potential can be formed therebetween through contact with the wires 12. By forming the wire guide assembly 14 and the top pressure roller 18 with metal portions contacting the wires 12, current can flow between the portion of the moving wires 12 which extend between the wire guide assembly 14 and the top pressure roller 18, thereby causing heating of this portion of the wires 12. The heating of the wires 12 can soften or melt the plastic sheet 20 in regions contacting the wires 12, allowing the pressure roll assembly 34 to push the wires 12 into the plastic sheet 20 to embed the wires 12 into the plastic sheet 20 along the line of contact 33 of the pressure roll assembly 34. Since the wires 12 are embedded into the plastic sheet 20 along the line of contact 33, the side to side oscillation of the wires 12 by the wire guide assembly 14 causes the wires 12 to be embedded side by side or parallel to each other with the wave pattern 76 as the wires 12 move from side to side, which forms wire mat 22 (FIG. 2). At this stage, the wire mat 22 can be a continuous sheet.

A pinch roll assembly or arrangement 21 having a first or top pinch roller 23 and a second or bottom pinch roller 25 can be positioned downstream from the pressure roll assembly 34 and can also be driven by the drive system 80 for further driving the wire mat 22. A processing station 29 can be located downstream from the pressure roll assembly 34 and the pinch roller assembly 21 for further processing of the wire mat 22.

Referring to FIGS. 3 and 4, the processing station 29 can embed a buss bar conductor assembly or arrangement 79 having a series of buss bar conductors 24 into the wire mat 22. The buss bars 24 can have at least one exterior side clad with an exposed layer of solder 26. The buss bars 24 can be embedded into the wire mat 22 with the exposed layer of solder 26 facing and embedded into the plastic sheet 20 to provide the desired electrical circuit. Selected buss bars 24 are soldered to particular wires 12 (FIG. 4) that are embedded in the plastic sheet 20. Soldering can be accomplished under heat, pressure or resistance. The exposed solder clad surface on the side of the buss bars 24 that faces and is embedded into the plastic sheet 20 is melted, thereby soldering the wires 12 within the exposed solder 26, so that the wires 12 can be soldered to only one side of the buss bars 24 within the plastic sheet 20. As a result, a single conductor or buss bar 24 can be soldered to only one side of the wires 12 on one exposed or exterior side of the buss bar 24, and the wires 12 do not have to be sandwiched between two conductive surfaces. In addition, the embedded buss bar arrangement 79 can have a low profile. In some embodiments, only the layer of solder 26 can be embedded into the plastic sheet 20. The wire mat 22 can be cut to particular lengths 77 as shown in FIG. 3, for example, by a rotating cutter or die, a guillotine cutter, or a steel rule die. Referring to FIG. 4, the wire mat can be cut to the desired shape 28, for example by a steel rule die, and can have flexible electrical connectors 32 secured in electrical connection with the buss bars 24 to provide power to the wires 12, thereby forming the finished wire mat or heater 30. The shape 28 can be cut from a continuous wire mat 22 or from the lengths 77 shown in FIG. 3. The order of these various operations can be different depending upon the situation at hand.

Referring to FIG. 5A, the finished wire mat 30 can be laminated between window sheets 122 to form a window 120, such as a windshield or rear window. The window sheets 122 can be formed of glass, or can be a suitable plastic, for example, polycarbonate or LEXAN®. In addition, a plastic window can be formed by placing the wire mat 30 in a mold and pouring or injecting plastic around the wire mat 30 to form the window sheets 122. The plastic sheet 20 can be made of other suitable plastics, for example, polycarbonate or LEXAN®. Furthermore, wire mats formed of wires 12 and a buss bar arrangement 79 without a plastic sheet 20 can be formed within a window 120. The wire mat 30 within the window 120 can be a heater for defrosting purposes. Alternatively, the wire mat 30 can serve other purposes, for example, an antenna. In some embodiments, the window 120 can include wire mat 22.

In particular embodiments, the plastic sheet 20 can be a suitable material such as polyvinyl butyral (PVB) about 0.030 inches thick. The buss bars 24 can be formed of copper about 0.005 inches thick and the layer of solder 26 can be about 0.002 inches thick. Depending upon the situation, the buss bars 24 can be partially or completely embedded into the plastic sheet 20. The wires 12 can be formed of tungsten and can have a diameter of about 0.001 inches. The wave pattern 76, in one example, can have waves that are about ⅜ inches long with a total amplitude of about ⅛ inches. The length and amplitude of the wave pattern 76 can be changed or controlled by controlling the longitudinal speed of the plastic sheet 20 and the wires 12, and the amount and speed of the side to side oscillation of the wires 12. It is understood that the dimensions described above can vary, depending upon the situation at hand. In some embodiments, the processing station 29 can perform only some selected operations. In other embodiments, the processing station 29 can include a wind-up station for winding the wire mat 22 onto a spool which can be processed later.

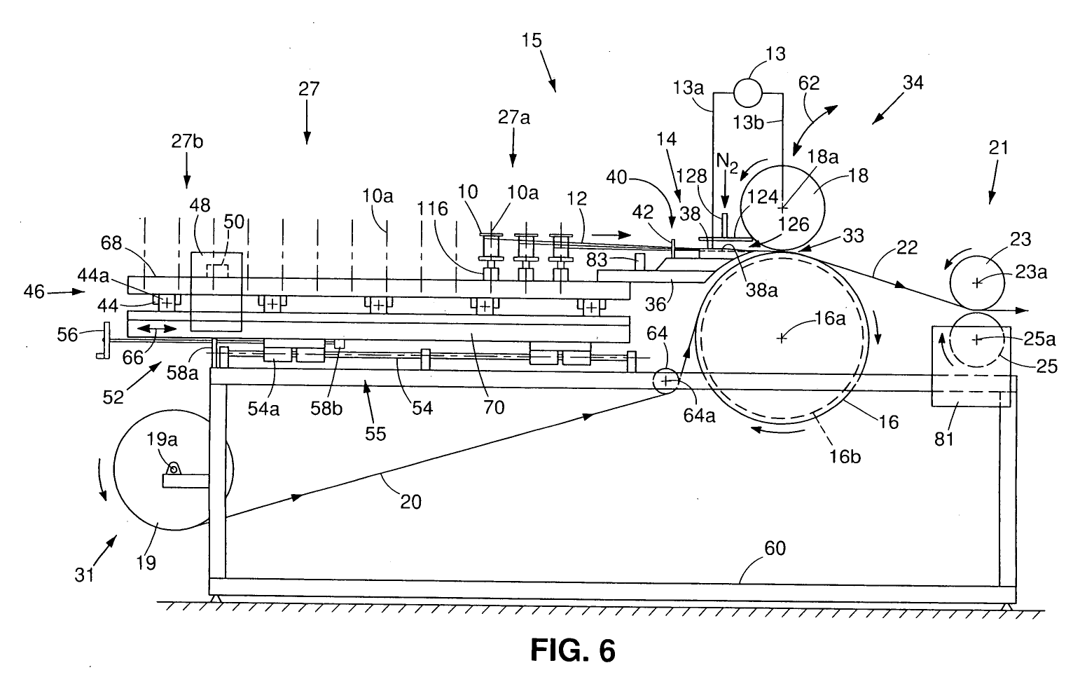

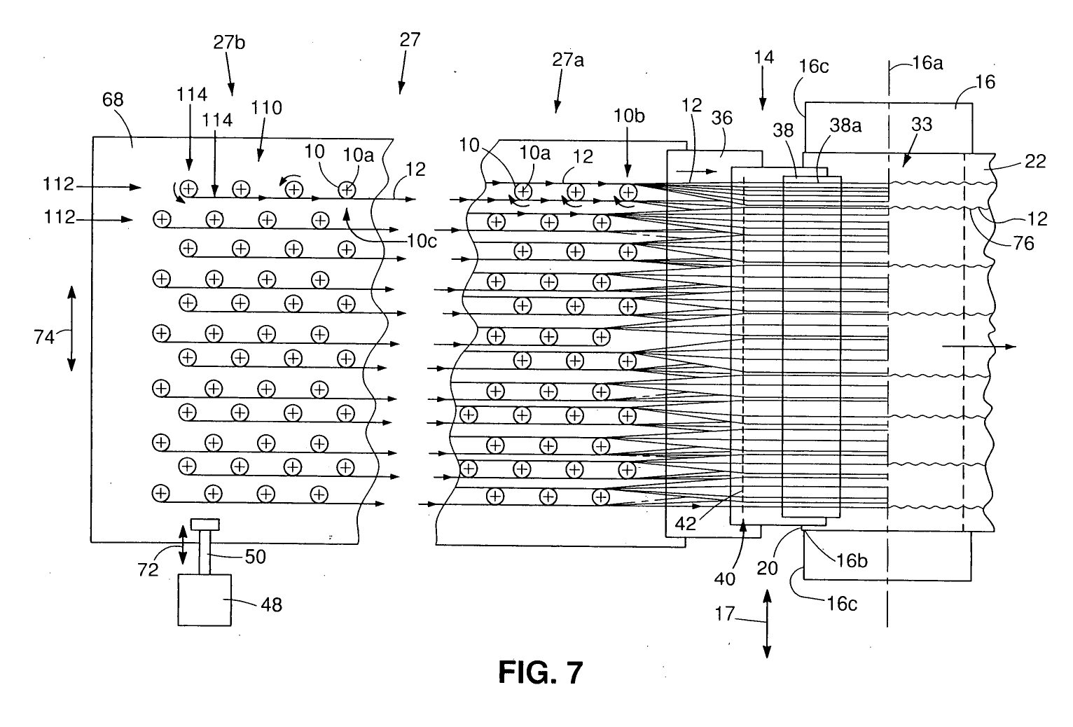

Referring to FIGS. 6 and 7, an embodiment of apparatus 15 can have a frame 60 to which the plastic sheet unwind station 31 can be mounted at a lower region. The roll 19 of the plastic sheet 20 can be rotatably supported or mounted about a rotatable axis 19a for unwinding the plastic sheet 20. A brake, clutch or motor can be employed to control the tension of the plastic sheet 20 while unwinding. The unwind station 31 can also be located at other suitable locations than that shown. Depending upon the position of the unwind station 31, an idler roller 64 can be employed to aid in guiding or directing the plastic sheet 20 to the pressure roll assembly 34 and can be rotatably mounted about a rotatable axis 64a.

The wire unwind station 27 can include an unwind mounting structure, assembly, table or platform 68 to which a series of spools 10 of wire 12 can be rotatably mounted and arranged in a matrix 110 which can have a series of longitudinal rows 112 and lateral columns 114. The spools 10 can be staggered as shown or, alternatively, can be in alignment. The spools 10 can be positioned along a common horizontal plane and rotatably mounted about rotatable vertical axes 10a. Each spool 10 can supply a single strand of wire 12. For example, 100 spools can provide 100 strands of wire 12, 500 spools 10 can provide 500 strands of wire 12, and 600 spools 10 can provide 600 strands of wire 12. Each spool 10 can be mounted to a tension device 116 such as a brake or clutch which can provide tension of the wire 12 while being unwound. The tension device 116 can be magnetically operated, but alternatively can be operated by other suitable means, such as by mechanical, electric, or pneumatic means. In at least a portion of each row 112 of spools 10, the strands of wire 12 can be unwound from the same side as shown in FIG. 7. Depending upon the longitudinal length of the unwind station 27, a first or front portion 27a of the unwind station 27 can unwind from one side 10b, for example, clockwise, and a second or rear portion 27b can unwind from the opposite side 10c, for example, counterclockwise. This can aid in evenly distributing the wires 12. Wires 12 that are unwound can be near or contact against the sides of downstream spools 10 in the same row 112 as shown. The downstream spools 10 of the front portion 27a of the unwind station 27 can have wires 12 that are near or in contact on both sides. The wires 12 contacting downstream spools 10 can move forward without adverse affect. A wire sensing system 83 (FIG. 6) can be employed for sensing the absence of a wire 12 due to breakage, or a spool 10 that runs out of wire 12. In one embodiment, drop pins can be hung from each wire 12 and if a pin falls, a sensor can be tripped. Alternatively, other suitable systems can be used.

The wire guide assembly 14 can be mounted to the table 68 downstream from the unwind station 27. The wire guide assembly 14 can have a first stage wire guide 40 for initially spacing the wires 12 apart from each other as the wires 12 leave the unwind station 27. The first stage wire guide 40 can be comblike and can have a series of protrusions or pins 42 which can be spaced apart from each other in a linear or lateral row for separating the wires 12 and guiding the wires through spaces or slots between the pins 42. The pins 42 can be of sufficient length or height to allow the wires 12 to move up and down in the spaces between the pins 42 as the wires 12 unwind from different heights or locations on their respective spools 10. The vertical positioning of the first stage wire guide 40 can also be employed for compensating for different wire 12 heights arriving from the unwind station 27. If desired, the first stage wire guide 40 can have an enclosed top for preventing the wires 12 from escaping out the top. Alternatively, the first stage wire guide 40 can include a series of vertical slots, grooves, spaces or recesses formed in a laterally positioned member.

A second stage wire guide 38 can be positioned downstream from the first stage wire guide 40 for further alignment and guidance of the wires 12 onto the plastic sheet 20. The second stage wire guide 38 can include a plate having a series of parallel grooves 38a in which the wires 12 are guided with the desired spacing for alignment on the plastic sheet 20. The first stage wire guide 40 can position the wires 12 in a side by side relationship with an initial intermediate lateral and vertical alignment and spacing, and the second stage wire guide 38 can further complete the positioning of the wires 12 in the desired lateral and vertical alignment and spacing. The grooves 38a can be spaced apart from each other by about the desired lateral spacing distance of the wires 12 on the plastic sheet 20. The depth of the grooves 38a can be constant to align the wires 12 at the same vertical height and can be made to prevent the wires 12 from escaping out the top. The vertical alignment of the wires 12 can be provided by guiding the wires 12 on the bottom of the grooves 38a or alternatively, over a lateral member or structure positioned across the grooves 38a at a constant vertical height. The grooves 38a can have an enclosed top. The width of the grooves 38a can be constant, or can taper moving in the downstream direction, and can be formed with enough clearance relative to the diameter of the wires 12 to allow sliding of the wires 12. Alternatively, the spacing of the grooves 38a can be angled or tapered in a converging fashion. The power supply 13 can be electrically connected to the second stage wire guide 38 by line 13a. Sliding of the wires 12 over the wire guide 38 and through the grooves 38a allows the wires 12 to be in electrical contact with the wire guide 38 and the power supply 13. The first 40 and second stage 38 wire guides can be mounted to the table 68 by a mounting plate assembly 36. The second stage wire guide 38 and the mounting plate assembly 36 can have contoured underside surfaces to allow the second stage wire guide 38 to be positioned close to the bottom pressure roller 16 of the pressure roll assembly 34. In some embodiments, the first stage wire guide 40 can be omitted. In other embodiments, the first 40 and/or second 38 stage wire guides can include rolling components for reducing friction on the moving wires 12 and can be arranged in other suitable orientations and configurations.

An inert gas, such as nitrogen (N₂) can be supplied by a supply line 128 (FIG. 6) to an enclosure 124 mounted above the wire guide assembly 14, for example, over the second stage wire guide 38. This can push out oxygen and form an inert gas chamber 126 over the wires 12 in the location where the wires 12 are heated by the power supply 13. The inert atmosphere can reduce or prevent oxidation of the wires 12 when heated which can reduce or prevent breakage of the wires 12. In other embodiments, other suitable inert gases can be employed, such as helium. Alternatively, the enclosure 124 can be evacuated to reduce the amount of oxygen present.

By being both mounted to the table 68, the wire unwind station 27 and the wire guide assembly 14 can be oscillated together in unison side to side as shown by the arrows 74 and 17 (FIG. 7) relative to the pressure roll assembly 34, with oscillation of the table 68. The table 68 can be supported by a lateral movement system 46 having a series of slides linear bearings. The table 68 can be mounted to a series of bearing blocks 44 that slide on linear rails 44a which are laterally aligned to allow lateral sliding of the table 68 from side to side in the direction of arrows 74. The linear rails 44a can be mounted to an intermediate frame 70. The table 68 can be oscillated by a motor drive 48 having a linkage 50 that is secured to the table 68 and which moves back and forth or reciprocates in the direction of arrows 72. The motor 48 can be mounted to intermediate frame 70. Other suitable linear actuators can be employed to oscillate the table 68.

The wire guide assembly 14 and the unwind station 27 can also be adjustably moved closer to or further apart from the pressure roll assembly 34 by a longitudinal adjustment system 52 as shown by arrows 66 (FIG. 6). The intermediate frame 70 can be mounted to a longitudinal slide system 55 having a series of linear bearings. The intermediate frame 70 can be mounted to a series of bearing blocks 54a that slide on linear rails 54 which are aligned to allow sliding of the intermediate frame 70 longitudinally relative to frame 60. An adjusting screw 56 can be mounted to the frame 60 through a threaded bearing block 58a and rotatably coupled to the intermediate frame 70 by a rotatable joint 58b. The adjusting screw 56 can move the intermediate frame 70 towards and away from the pressure roll assembly 34, thereby also moving the unwind station 27 and the wire guide assembly 14 towards and away from the pressure roll assembly 34. The adjusting screw 56 can be operated by hand or by a motor. In addition, other suitable linear actuators can be employed. In some embodiments, the longitudinal adjustment system 52 can be omitted. In such an embodiment, the lateral movement system 46 can be mounted to the frame 60.

The bottom pressure roller 16 of the pressure roll assembly 34 can act as an anvil and can be made of steel with chrome plating. The bottom pressure roller 16 can be rotatably mounted to the frame 60 about a rotatable axis 16a. The bottom pressure roller 16 can have a center surface region that has a smaller diameter 16b or is recessed to aid in the tracking or guiding of the plastic sheet 20 between shoulders 16c. The depth of the recess can control the pressure characteristics of the pressure roll assembly 34 on the plastic sheet 20 and the wires 12. In some embodiments, the bottom pressure roller can be a vacuum roller for holding the plastic sheet 20 more securely. In addition, depending upon the situation at hand, the bottom pressure roller 16 can be in electrical circuit for heating wires 12.

The top pressure roller 18 of the pressure roll assembly 34 can be rotatably mounted about a rotatable axis 18a. The top pressure roller 18 can have a smaller diameter than the bottom pressure roller 16 and can be moved towards and away from the bottom pressure roller 16, and can be adjusted to provide the desired amount of pressure along with line of contact 33. In one embodiment, the top pressure roller 18 can be moved toward and away from the bottom pressure roller 16 along an arc as indicated by arrows 62. In other embodiments, the top roller 18 can be moved along a linear path, for example, vertically or at an angle. The top pressure roller 18 can have an outer surface that is formed of a metal such as copper for heat sink and/or electrical conductivity purposes when in contact with the wires 12. Alternatively, the outer surface can be formed of other suitable electrically conductive materials, such as steel, aluminum, etc. The rolling contact of the top pressure roller 18 with the moving wires 12 can maintain electrical contact between the top roller pressure 18 and the wires 12 so that current can flow between the portion of the wires 12 extending between the wire guide assembly 14 and the top pressure roller 18.

Referring to FIG. 8, the top pressure roller 18 can be rotatably mounted about rotatable axis 18a to a moveable assembly 90 which can move the top pressure roller 18 towards and away from the bottom pressure roller 16. The top pressure roller 18 can be pivotably mounted to an upper frame member 100 which extends from frame 60 by an arm 98 which can pivot about a pivot point 102. The arm 98 can be pivotably moved in the direction of arrows 62 by a linear actuator 104, such as a pneumatic cylinder, which can be mounted between the frame 100 and the arm 98 by joints 106 and 108. The linear actuator 104 can be adjusted to the desired position or to provide the desired amount of pressure that is exerted by the pressure roll assembly 34 on the plastic sheet 20 and the wires 12 along the line of contact 33. In some embodiments, the linear actuator 104 can be other suitable devices such as a hydraulic cylinder, ball screw device, mechanical linkage, etc., or can be replaced by a rotary actuator.

The pinch rollers 23 and 25 of the pinch roll assembly 21 can be rotatably mounted to the frame 60 about rotatable axes 23a and 25a downstream from the pressure roll assembly 34. The pinch roll assembly 21 can be driven at a slightly faster speed than the pressure roll assembly 34 to maintain tension on the wire mat 22. The pinch rollers 23 and 25 can have elastomer surfaces, such as urethane to grip the wire mat 22.

Referring to FIGS. 6 and 8, the pressure roll assembly 34 and the pinch roll assembly 21 can be driven by a drive system 80. The drive system 80 can include a motor drive 81 coupled to the pinch roll assembly 21 for driving the pinch roll assembly 21. In the embodiment shown, the motor drive 81 can be coupled to and drive the bottom pinch roller 25, but can alternatively drive the top pinch roller 23 or both pinch rollers 23 and 25. The bottom pinch roller 25 can have a pulley 78 which can be driveably coupled or connected by a belt 82 to a pulley 86 on the bottom pressure roller 16 of the pressure roll assembly 34 for driving the bottom pressure roller 16. The pulley 78 can be at the opposite end of the pinch roller 25 from the motor drive 81. An idler roller 84 rotatable about axis 84a can help maintain tension of the belt 82. The top pressure roller 18 can be driven by a gear 88 mounted to the bottom pressure roller 16 which can engage and drive a gear 92 mounted to top pressure roller 18, when the top pressure roller 18 is moved into a pressure exerting position relative to the bottom pressure roller 16. The gears 88 and 92 can engage and disengage by moving the top pressure roller 18 into and out of position in an arc in the direction of arrows 62. The gear 92 and a pulley 93 can be rotatably mounted to the arm 98 about a rotatable axis 92a. The pulley 93 can be driven by the gear 92. The pulley 93 can be coupled to and drive the top pressure roller 18 by belt 94 and pulley 96. In some embodiments, one of the pressure rolls 16 and 18 may be driven. In other embodiments, only the pinch roll assembly 21 can be driven. In further embodiments, the pinch roll assembly 21 can be omitted. The belts 82 and 94 can be timing belts, but alternatively can be other suitable transmission elements such as v-belts or chains. Also, the drive system 80 can transmit power through gear trains. The pinch roll assembly 21 and the pressure roll assembly 34 can also have separate drives.

While this invention has been particularly shown and described with references to particular embodiments thereof, it will be understood by those skilled in the art that various changes in form and details may be made therein without departing from the scope of the invention encompassed by the appended claims.

For example, in some embodiments, the spools 10 can be oriented to rotate about horizontal axes either parallel, at an angle, or perpendicular to the pressure roll assembly 34. In addition, the multiple wires 12 can be unwound from a single spool at the unwind station. Also, the pressure roll assembly 34 can be oriented so that the rollers 16 and 18 are laterally positioned or at an angle. In some embodiments, the matrix of spools 10 can have rows of spools that are longitudinally angled, for example, in a vee pattern. In further embodiments, the wires 12 can be applied to the plastic sheet 20 without heating the wires 12 with current, for example, by using an external heat source or adhesives. Also, the wires 12 can be applied in other suitable patterns or can be applied in straight lines. In some embodiments, only the wire guide assembly 14 can be oscillated. In other embodiments, the pressure roll assembly 34 can be oscillated.

What is claimed is:

1. An apparatus for forming a wire mat comprising:
a wire guide for simultaneously guiding multiple moving wires onto a moving plastic sheet; and
a pressure roll arrangement downstream from the wire guide including a first pressure roller and a second pressure roller engageable with the first pressure roller, the pressure rollers for applying pressure along a line of contact for combining the multiple wires with the plastic sheet between the rollers, the wire guide and one of the pressure rollers being configured to allow a voltage potential to be formed between the wire guide and said one of the pressure rollers for causing current to flow and heating of a portion of the wires between the wire guide and said one of the pressure rollers, the portion of the wires that is heated being capable of heating portions of the plastic sheet to allow the wires to be embedded into the plastic sheet by the pressure rollers along the line of contact to form a wire mat.

2. The apparatus of claim 1 further comprising an oscillating drive system for providing relative side to side oscillation between the wire guide and the pressure rollers for applying the wires on the plastic sheet in a wave pattern.

3. The apparatus of claim 2 in which the pressure rollers of the pressure roll arrangement are driven by a drive system.

4. The apparatus of claim 2 in which the multiple wires are drawn from respective multiple spools.

5. The apparatus of claim 4 in which the multiple spools and the wire guide are oscillated side to side in unison by the oscillating drive system.

6. The apparatus of claim 5 in which the spools are positioned along a horizontal plane in rows, the spools being rotatable about vertical axes.

7. The apparatus of claim 2 in which the wire guide is capable of oscillating side to side while the pressure roll arrangement remains stationary, whereby the wave pattern of the wires is formed on the plastic sheet at the line of contact of the pressure rollers.

8. The apparatus of claim 7 in which the first pressure roller is a top roller, the voltage potential being formed between the wire guide and the top pressure roller.

9. The apparatus of claim 1 in which the wire guide includes a series of lateral slots.

10. The apparatus of claim 1 in which the wire guide is configured for simultaneously guiding at least 100 wires side by side onto the plastic sheet.

11. The apparatus of claim 1 further comprising a pinch roll arrangement including a first pinch roller and a second pinch roller, located downstream from the pressure roll arrangement, the pinch roll arrangement also being driven by the drive system.

12. An apparatus for forming a wire mat comprising:
a wire guide for simultaneously guiding multiple moving wires from respective multiple spools onto a moving plastic sheet; and
a pressure roll arrangement downstream from the wire guide including a first pressure roller and a second pressure roller engageable with the first pressure roller, the pressure rollers for applying pressure along a line of contact for combining the multiple wires with the plastic sheet between the rollers to form a wire mat; and
an oscillating drive system for providing relative side to side oscillation between the wire guide and the pressure rollers for applying the wires on the plastic sheet in a wave pattern, the multiple spools and the wire guide being oscillated side to side in unison by the oscillating drive system.

13. The apparatus of claim 12 in which the pressure rollers of the pressure roll arrangement are driven by a drive system.

14. The apparatus of claim 12 in which the spools are positioned along a horizontal plane in rows, the spools being rotatable about vertical axes.

15. The apparatus of claim 12 in which the wire guide is capable of oscillating side to side while the pressure roll arrangement remains stationary, whereby the wave pattern of the wires is formed on the plastic sheet at the line of contact of the pressure rollers.

16. The apparatus of claim 15 in which the wire guide and one of the pressure rollers is configured to allow a voltage potential to be formed between the wire guide and said one of the pressure rollers for causing current to flow and heating of a portion of the wires between the wire guide and said one of the pressure rollers, the portion of the wires that is heated being capable of heating portions of the plastic sheet to allow the wires to be embedded into the plastic sheet by the pressure rollers along the line of contact to form a wire mat.

17. The apparatus of claim 16 in which the first pressure roller is a top roller, the voltage potential being formed between the wire guide and the top pressure roller.

18. The apparatus of claim 12 in which the wire guide includes a series of lateral slots.

19. The apparatus of claim 12 in which the wire guide is configured for simultaneously guiding at least 100 wires side by side onto the plastic sheet.

20. The apparatus of claim 12 further comprising a pinch roll arrangement including a first pinch roller and a second pinch roller, located downstream from the pressure roll arrangement, the pinch roll arrangement also being driven by the drive system.

21. A wire mat comprising:
a plastic sheet;
a series of wires embedded in the plastic sheet; and
a buss bar arrangement including buss bars, at least some of the buss bars having an exposed solder clad surface embedded into the plastic sheet and facing and being soldered to at least some of the embedded wires.

22. The wire mat of claim 21 further comprising an electrical connector arrangement electrically connected with the buss bars.

23. The wire mat of claim 22 in which the wire mat is a heating element and the wires are heating wires.

24. The wire mat of claim 21 in which the wires are embedded in the plastic sheet side by side in wave patterns.

25. A window comprising:
a first window sheet;
a second window sheet; and
a wire mat between the window sheets, the wire mat comprising a plastic sheet, a series of wires embedded in the plastic sheet, and a buss bar arrangement including buss bars, at least some of the buss bars having an exposed solder clad surface embedded into the plastic sheet and facing and being soldered to at least some of the embedded wires.

26. The window of claim 25 in which the wire mat is a heating element and the wires are heating wires.

27. The window of claim 25 further comprising an electrical connector arrangement electrically connected with the buss bars.

28. The window of claim 25 in which the wires are embedded in the plastic sheet side by side in wave patterns.

29. A method for forming a wire mat comprising:
simultaneously guiding multiple moving wires onto a moving plastic sheet with a wire guide;
combining the multiple wires with the plastic sheet with a pressure roll arrangement downstream from the wire guide along a line of contact between a first pressure roller and a second pressure roller; and
forming a voltage potential between the wire guide and one of the pressure rollers for causing current to flow and heating of a portion of the wires between the wire guide and said one of the pressure rollers, the portion of the wires that is heated being capable of heating portions of the plastic sheet to allow the wires to be embedded into the plastic sheet by the pressure rollers along the line of contact to form a wire mat.

30. The method of claim 29 further comprising providing relative side to side oscillation between the wire guide and the pressure rollers with an oscillating drive system for applying the wires on the plastic sheet in a wave pattern.

31. The method of claim 30 further comprising driving the pressure rollers of the pressure roll arrangement with a drive system.

32. The method of claim 30 further comprising drawing the multiple wires from respective multiple spools.

33. The method of claim 32 further comprising oscillating the multiple spools and the wire guide side to side in unison with the oscillating drive system.

34. The method of claim 33 further comprising positioning the spools along a horizontal plane in rows, the spools being rotatable about vertical axes.

35. The method of claim 30 further comprising oscillating the wire guide side to side while the pressure roll arrangement remains stationary, whereby the wave pattern of the wires is formed on the plastic sheet at the line of contact of the pressure rollers.

36. The method of claim 35 in which the first pressure roller is a top roller, the method further comprising forming the voltage potential between the wire guide and the top pressure roller.

37. The method of claim 29 further comprising providing the wire guide with a series of lateral slots.

38. The method of claim 29 further comprising configuring the wire guide for simultaneously guiding at least 100 wires side by side onto the plastic sheet.

39. The method of claim 29 further comprising positioning a pinch roll arrangement including a first pinch roller and a second pinch roller, downstream from the pressure roll arrangement, the pinch roll arrangement also being driven by the drive system.

40. A method for forming a wire mat comprising:
simultaneously guiding multiple moving wires from respective multiple spools onto a moving plastic sheet with a wire guide;
combining the multiple wires with the plastic sheet with a pressure roll arrangement downstream from the wire guide along a line of contact between a first pressure roller and a second pressure roller to form a wire mat; and
providing relative side to side oscillation between the wire guide and the pressure rollers with an oscillating drive system for applying the wires on the plastic sheet in a wave pattern, the multiple spools and the wire guide being oscillated side to side in unison by the oscillating drive system.

41. The method of claim 40 further comprising driving the pressure rollers of the pressure roll arrangement with a drive system.

42. The method of claim 40 further comprising positioning the spools along a horizontal plane in rows, the spools being rotatable about vertical axes.

43. The method of claim 40 further comprising oscillating the wire guide side to side while the pressure roll arrangement remains stationary, whereby the wave pattern of the wires is formed on the plastic sheet at the line of contact of the pressure rollers.

44. The method of claim 43 further comprising forming a voltage potential between the wire guide and one of the pressure rollers for causing current to flow and heating of a portion of the wires between the wire guide and said one of the pressure rollers, the portion of the wires that is heated being capable of heating portions of the plastic sheet to allow the wires to be embedded into the plastic sheet by the pressure rollers along the line of contact to form a wire mat.

45. The method of claim 44 in which the first pressure roller is a top roller, the method further comprising forming the voltage potential between the wire guide and the top pressure roller.

46. The method of claim 40 further comprising providing the wire guide with a series of lateral slots.

47. The method of claim 40 further comprising configuring the wire guide for simultaneously guiding at least 100 wires side by side onto the plastic sheet.

48. The method of claim 40 further comprising positioning a pinch roll arrangement including a first pinch roller and a second pinch roller, downstream from the pressure roll arrangement, the pinch roll arrangement also being driven by the drive system.

49. A method of forming a wire mat comprising:
providing a plastic sheet;
embedding a series of wires in the plastic sheet; and
applying a buss bar arrangement having buss bars on the plastic sheet, at least some of the buss bars having an exposed solder clad surface embedded into the plastic sheet and facing and being soldered to at least some of the embedded wires.

50. The method of claim 49 further comprising electrically connecting an electrical connector arrangement with the buss bars.

51. The method of claim 50 further comprising forming the wire mat as a heating element and the wires as heating wires.

52. The method of claim 50 further comprising embedding the wires in the plastic sheet side by side in wave patterns.

53. A method of forming a window comprising:
positioning a wire mat between first and second window sheets, the wire mat comprising a plastic sheet, a series of wires embedded in the plastic sheet, and a buss bar arrangement including buss bars, at least some of the buss bars having an exposed solder clad surface embedded into the plastic sheet and facing and being soldered to at least some of the embedded wires.

54. The method of claim 53 further comprising forming the wire mat as a heating element and the wires as heating wires.

55. The method of claim 53 further comprising electrically connecting an electrical connector arrangement with the buss bars.

56. The method of claim 53 further comprising embedding the wires in the plastic sheet side by side in wave patterns.

57. A method of forming a window comprising:
forming a plastic window having two sides, a wire mat being positioned 5 between the two sides, the wire mat comprising a series of wires in electrical circuit with a buss bar arrangement.
